(19) United States
(12) Patent Application Publication
(10) Pub. No.: US 2009/0003012 A1
(43) Pub. Date: Jan. 1, 2009

(54) Lighting tree

(75) Inventor: Sheng-Hung Hsu, Kaohsiung Hsien (TW)

Correspondence Address: Joe McKinney Muncy, PO Box 1364, Fairfax, VA, 22038-1364, US

(73) Assignee: GEMMY INDUSTRIES CORPORATION

(21) Appl. No.: 11/819,457

(22) Filed: Jun. 27, 2007

(51) Int. Cl. F21V 8/00; F21S 6/00

(52) U.S. Cl. 362/567; 362/123

(57) ABSTRACT

A lighting tree has a base, a stand mounted on the base, multiple lighting branches connected to the stand, multiple lighting leaves expanding from each lighting branch, and a control box incorporated with a speaker. Each lighting branch has a lighting element mounted in one end of the lighting branch. The control box determines whether the lighting elements should be activated. Based on different types of music output by the speaker, the control box determines the lighting branches and lighting leaves to be turned on or off.

### BACKGROUND OF THE INVENTION

1. Field of the Invention

The invention relates to a lighting tree and, in particular, to a lighting tree that generates sounds and has multiple branches and leaves capable of generating light.

2. Description of Related Art

Many different types of electronic ornaments are developed and manufactured in recent years to enrich decorative effects. However, a conventional Christmas tree may leave people with a monotonous impression even though colorful bulbs or light strings are decorated on the tree. Most of the bulbs or light strings are exposed on the decorative tree without any protecting elements, and thus may easily be damaged during transportation or installation.

### SUMMARY OF THE INVENTION

An objective of the invention is to provide a lighting tree that has multiple branches and leaves, and each branch can be individually controlled to generate light. In addition to the visual effects, the lighting tree is capable of generating sounds to enrich decorative effects.

To achieve the above-mentioned objective, the lighting tree has a base, a stand mounted on the base, multiple lighting branches connected to the stand, multiple lighting leaves expanding from each lighting branch, and a control box incorporated with a speaker. Each lighting branch has a lighting element mounted in one end of the lighting branch. The control box determines whether the lighting elements should be activated. Based on different types of music output by the speaker, the control box determines the lighting branches and lighting leaves to be turned on or off.

### BRIEF DESCRIPTION OF THE DRAWINGS

FIG. 1 is a perspective view of a lighting tree in accordance with the present invention;

FIG. 2 is a perspective view of a branch of the lighting tree of FIG. 1;

FIG. 3 is an enlarged perspective view of a portion of the branch of FIG. 2; and

FIGS. 4A-4D show a circuit diagram of a control circuit in accordance with the present invention.

### DETAILED DESCRIPTION OF THE PREFERRED EMBODIMENT

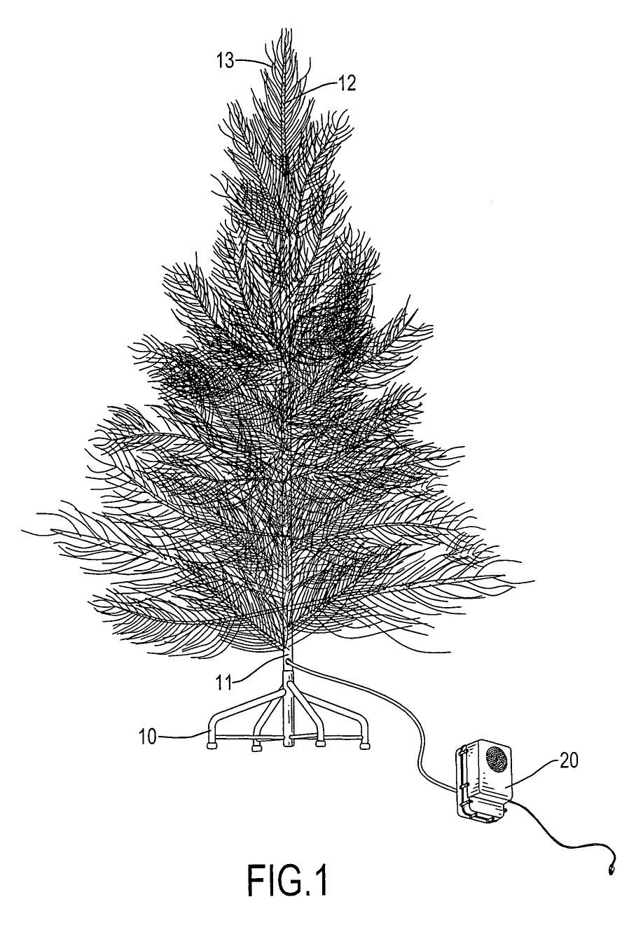

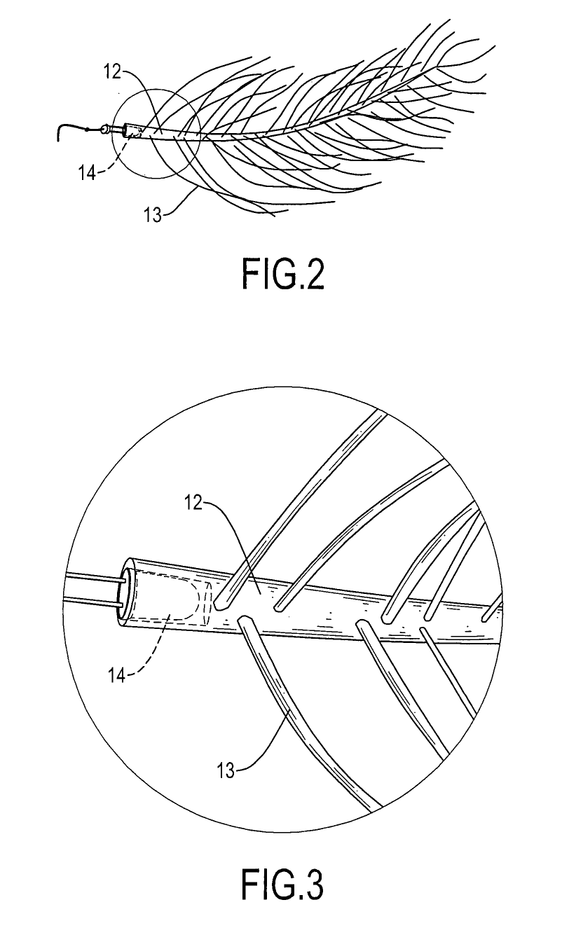

With reference to FIGS. 1 to 3, a lighting tree of the present invention comprises a base (10), a stand (11) mounted on the base (10), multiple branches (12) connected to the stand (11), multiple leaves (13) expanding from each of the branches (12) and a control box (20).

Each branch (12) may be a hollow tube with a lighting element (14) mounted in one end of the tube. The lighting element (14) can be a light emitting diode (LED) and controlled by the control box (20). The lighting element (14) is electrically connected to the control box (20) through wires.

The wires between the lighting elements (14) and the control box (20) can be mounted inside the hollow stand (11).

When the control box (20) activates the lighting elements (14) to produce light, the light is transmitted or guided to the leaves (13). The leaves (13) are needle leaves in this embodiment like the pine foliage and can consist of optic fibers. However, the leaves (13) can be designed to form any desired shapes. In addition to the leaves (13), optic fibers also can be mounted in the branches (13) so that entire branch (13) is able to generate light.

The control box (20) determines whether to activate the lighting elements (14) and connects with a wire to receive an AC power. The control box (20) further equips with a speaker (23) to output sounds.

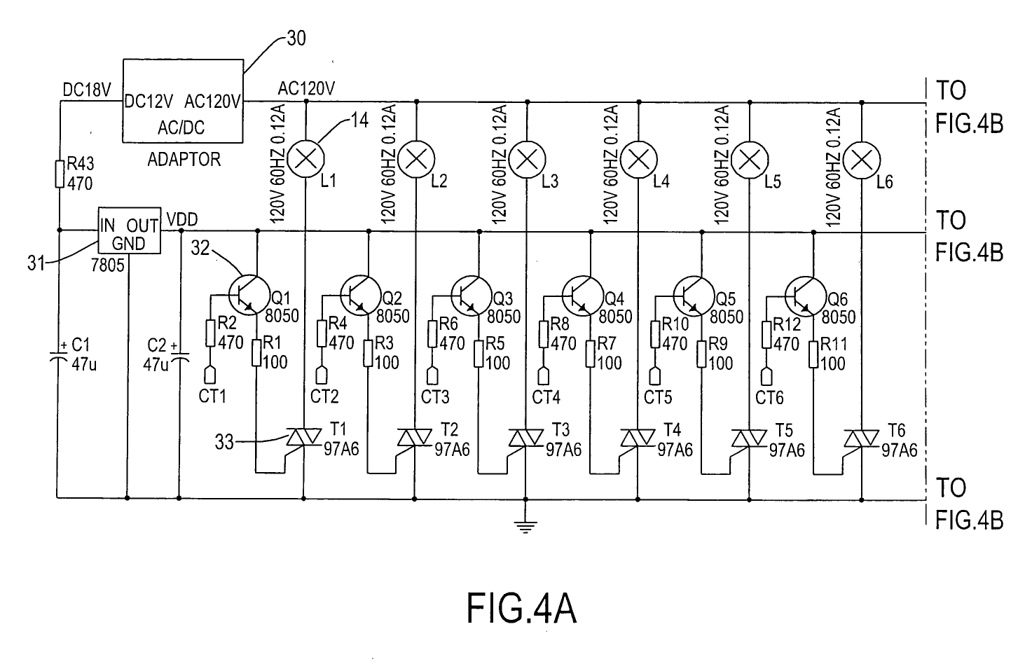

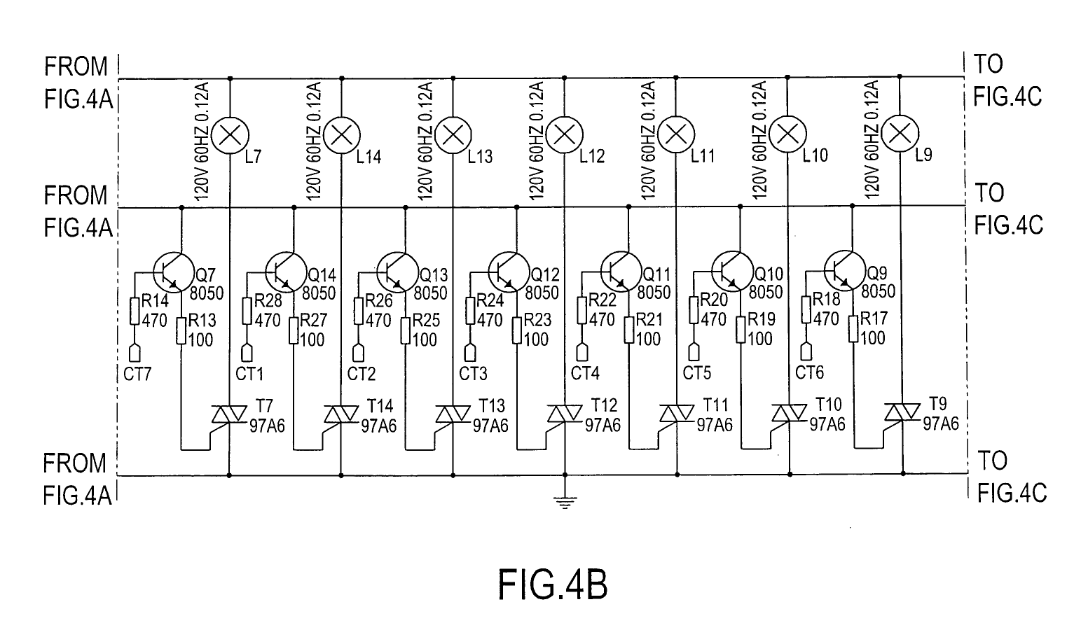

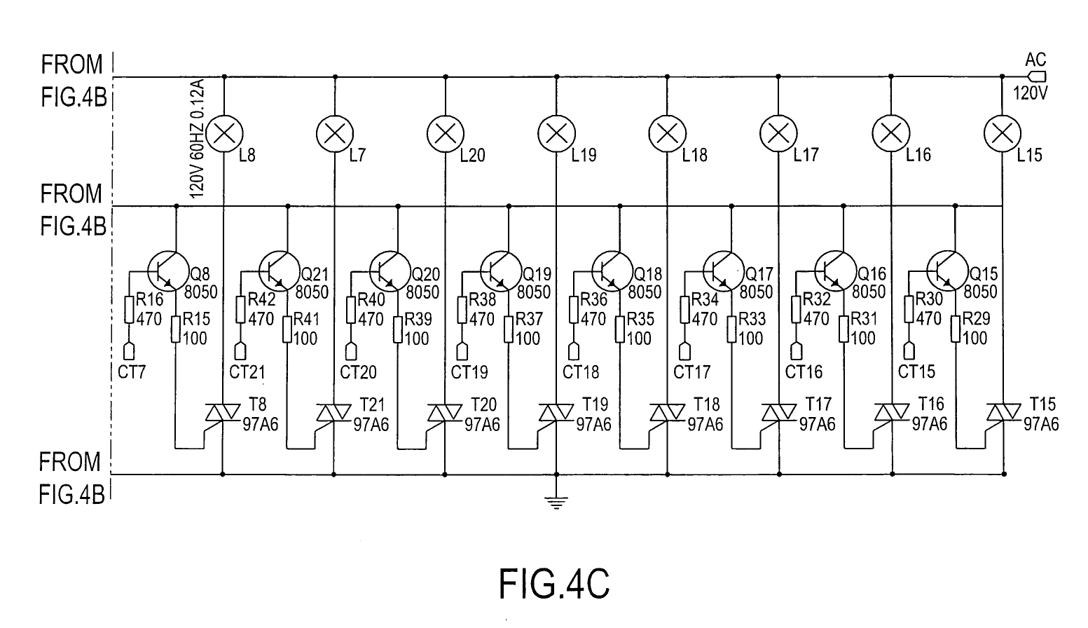

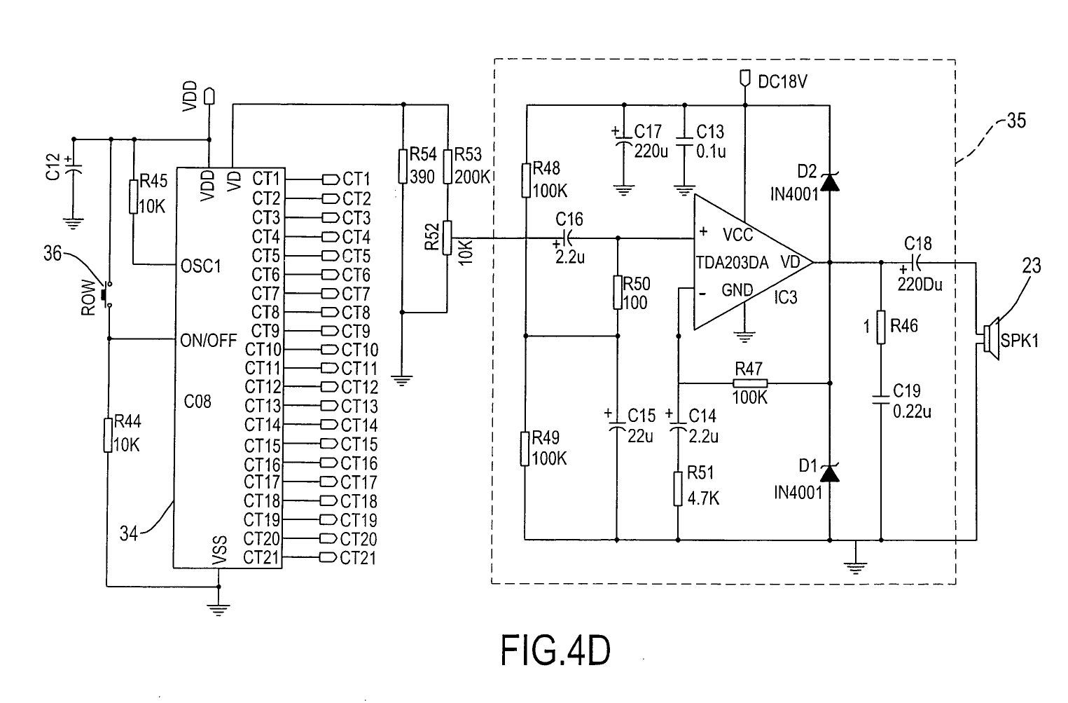

With reference to FIGS. 4A-4D, one embodiment of a circuit of the control box (20) comprises a voltage transformer (30), multiple control switches (32), multiple thyristors (TRIAC) (33), a central control circuit (34) and an audio amplify circuit (35).

The voltage transformer (30) is connected to the wire (21) to transform an input AC voltage to a first DC voltage. The first DC voltage is output to a voltage regulating circuit (31). The voltage regulating circuit (31), which can be an integrated circuit (IC), further transforms the incoming first DC voltage to a second DC voltage. In this embodiment the first DC voltage is 12 volts and the second DC voltage is 5 volts.

Each of the control switches (32) is connected between the output terminal of the voltage regulating circuit (31) and a respective thyristor (33), and has a control terminal in connection with the central control circuit (34). The control switch (32) can be implemented by a NPN transistor as shown in this embodiment, wherein a collector, an emitter and a base of the NPN transistor are respectively connect to the voltage regulating circuit (31), the respective thyristor (33) and the central control circuit (34).

Each of the multiple thyristors (33) has a first terminal, a second terminal and a trigger terminal. The first terminals of the multiple thyristors (33) connect to the lighting element (14). All the second terminals are connected to a ground. The trigger terminals are respectively connected to the control switches (32).

The central control circuit (34) can be implemented by an integrated circuit (IC). The central control circuit (34) has a voltage terminal connected to the output terminal of the voltage regulating circuit (34), multiple control signal output terminals (CT1 to CT11) respectively connected to the bases of the control switches (32), and an audio signal output terminal connected to the audio amplify circuit (35). The central control circuit (32) further connects with a power switch (36). When the power switch (36) is pressed, the central control circuit (34) is activated.

The audio amplify circuit (35) has an input terminal in connection with the audio signal output terminal of the central control circuit (34) and an output terminal coupled to the speaker (23).

When the central control circuit (34) outputs audio signals to the audio amplify circuit (35), the amplified audio signal processes and amplifies these audio signals and then further transmits to the speaker (23) to generate desired sound effects. The central control circuit (34) simultaneously, based on the audio signals, correspondingly outputs drive signals from its terminals (CT1 to CT11) to turn on the respective control switches (32). When the control switches (32) are turned on, a trigger voltage is input to the trigger terminals of the thyristors (33) corresponding to these control switches (32) to activate the thyristors (33). When the thyristors (33) are activated, a path is formed between the output of the voltage transformer (30). With the path, a current flows through the light string (12) to turn on the lighting elements.

In the present invention, the control box determines the sound and lighting effects of the lighting tree. Therefore, according to different music to be output, the light elements are correspondingly turned on or turned off to generate desired visual effect coordinating with the sound effect. As an example, for strong and fast music rhythm, a higher operating frequency is preferable to rapidly turn on or turn off the lighting elements of the branches. In addition to the operating frequency of the lighting elements, the lighting elements can be selectively activated with a according to the desired sequence.

What is claimed is:

1. A lighting tree comprising:
a base;
a stand mounted on the base;
multiple lighting branches connected to the stand, each lighting branch having one end in which a lighting element is mounted;
multiple lighting leaves expanding from each lighting branch; and
a control box connected to the multiple lighting branches and including a speaker mounted in the control box.

2. The lighting tree as claimed in claim 1, wherein each lighting leaf forms a shape of a needle leaf.

3. The lighting tree as claimed in claim 1, wherein the lighting leaves consist of optic fibers.

4. The lighting tree as claimed in claim 2, wherein the lighting leaves consist of optic fibers.

5. The lighting tree as claimed in claim 3, wherein the control box comprises
a voltage transformer having an input terminal connected to an AC voltage and an output terminal connected to an input terminal of a voltage regulating circuit, wherein the voltage transformer converts the AC voltage to a first DC voltage, and the voltage regulating circuit converts the first DC voltage to a second DC voltage;
multiple thyristors, each thyristor having a trigger terminal and being connected between at least one of the lighting elements and a ground;
multiple control switches respectively connected to the trigger terminals of the multiple thyristors;
a central control circuit having an audio signal output terminal, and multiple control signal output terminals respectively connected to the multiple control switches, the central control circuit outputting audio signals to the speaker to generate sounds and outputting driving signals to activate the lighting elements; and
an audio amplify circuit having an input terminal connected to the audio signal output terminal of the central control circuit to receive and amplify the audio signals, and having an output terminal connected to the speaker.

6. The lighting tree as claimed in claim 4, wherein the control box comprises
a voltage transformer having an input terminal connected to an AC voltage and an output terminal connected to an input terminal of a voltage regulating circuit, wherein the voltage transformer converts the AC voltage to a first DC voltage, and the voltage regulating circuit converts the first DC voltage to a second DC voltage;
multiple thyristors, each thyristor having a trigger terminal and being connected between at least one of the lighting elements and a ground;
multiple control switches respectively connected to the trigger terminals of the multiple thyristors;
a central control circuit having an audio signal output terminal, and multiple control signal output terminals respectively connected to the multiple control switches, the central control circuit outputting audio signals to the speaker to generate sounds and outputting driving signals to activate the lighting elements; and
an audio amplify circuit having an input terminal connected to the audio signal output terminal of the central control circuit to receive and amplify the audio signals, and having an output terminal connected to the speaker.

7. The lighting tree as claimed in claim 5, wherein each of the multiple control switches is a NPN transistor that has:
a base to receive the driving signal output from the central control circuit;
a collector connected to an output terminal of the voltage regulating circuit; and
an emitter connected to a respective one of the multiple thyristors;
wherein the multiple control switches are selectively turned on by the driving signals output from the central control circuit to activate the respective lighting elements to generate lights.

8. The lighting tree as claimed in claim 6, wherein each of the multiple control switches is a NPN transistor that has:
a base to receive the driving signal output from the central control circuit;
a collector connected to an output terminal of the voltage regulating circuit; and
an emitter connected to a respective one of the multiple thyristors;
wherein the multiple control switches are selectively turned on by the driving signals output from the central control circuit to activate the respective lighting elements to generate lights.

9. The lighting tree as claimed in claim 7, the control box further comprising a wire to connect to the AC voltage.

10. The lighting tree as claimed in claim 8, the control box further comprising a wire to connect to the AC voltage.

11. The lighting tree as claimed in claim 9, wherein the first DC voltage is 12 volts and the second DC voltage is 5 volts.

12. The lighting tree as claimed in claim 10, wherein the first DC voltage is 12 volts and the second DC voltage is 5 volts.

13. The lighting tree as claimed in claim 11, wherein the central control circuit further connects to a power switch.

14. The lighting tree as claimed in claim 12, wherein the central control circuit further connects to a power switch.
